(19) United States
(12) Patent Application Publication
(10) Pub. No.: US 2013/0228625 A1
(43) Pub. Date: Sep. 5, 2013

(54) ON DEMAND DECODING OF DECODABLE INDICIA

(71) Applicants: Ashish Sharma, Lucknow (IN); Dayaker Mupkala, Adilabad (IN); Manjul Bizoara, Hyderabad (IN)

(72) Inventors: Ashish Sharma, Lucknow (IN); Dayaker Mupkala, Adilabad (IN); Manjul Bizoara, Hyderabad (IN)

(73) Assignee: Honeywell International Inc. doing business as (d.b.a.) Honeywell Scanning & Mobility, Fort Mill, SC (US)

(21) Appl. No.: 13/412,008

(22) Filed: Mar. 5, 2012

(51) Int. Cl. G06K 7/10

(52) U.S. Cl. 235/470

(57) ABSTRACT

There is set forth herein an indicia reading apparatus having a plurality of configurations that can be activated with use of a manually actuated multiple state trigger. According to a first configuration the indicia reading apparatus can project a light pattern while maintaining in an inactive state decoding operations for attempting to decode a decodable indicia by processing of image data. According to a second configuration the indicia reading apparatus can activate decoding operations.

### FIELD OF THE INVENTION

The present invention relates in general to optical based registers, and particularly is related to an image sensor based indicia reading apparatus.

### BACKGROUND OF THE INVENTION

Indicia reading apparatus for reading decodable indicia are available in multiple varieties. For example, minimally featured indicia reading apparatus devoid of a keyboard and display are common in point of sale applications. Indicia reading apparatus devoid of a keyboard and display are available in the recognizable gun style form factor having a handle and trigger button (trigger) that can be actuated by an index finger. Indicia reading appartus having keyboards and displays are also available. Keyboards and display equipped indicia reading apparatus are commonly used in shipping and warehouse applications, and are available in form factors incorporating a display and keyboard. In a keyboard and display equipped indicia reading apparatus, a trigger button for actuating the output of decoded messages is typically provided in such locations as to enable actuation by a thumb of an operator. Indicia reading apparatus in a form devoid of a keyboard and display or in a keyboard and display equipped form are commonly used in a variety of data collection applications including point of sale applications, shipping applications, warehousing applications, security check point applications, and patient care applications.

Some indicia reading apparatus are adapted to read bar code symbols including one or more of one dimensional (1D) bar codes, stacked 1D bar codes, and two dimensional (2D) bar codes. Other indicia reading apparatus are adapted to read OCR characters while still other indicia reading apparatus are equipped to read both bar code symbols and OCR characters. An indicia reading terminal can have one or more of an image sensor based image data output system and a laser scanning based image data output system.

### SUMMARY OF THE INVENTION

There is set forth herein an indicia reading apparatus having a plurality of configurations that can be activated with use of a manually actuated multiple state trigger. According to a first configuration the indicia reading apparatus can project a light pattern while maintaining in an inactive state decoding operations for attempting to decode a decodable indicia by processing of image data. According to a second configuration the indicia reading apparatus can activate decoding operations.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 is a physical form view of an indicia reading apparatus;

FIG. 2 is a physical form view of an indicia reading apparatus in an alternative embodiment;

FIG. 3 is a representation of a target substrate having a plurality of decodable indicia;

FIG. 4 is a block diagram of an indicia reading apparatus;

FIG. 5 is a timing diagram illustrating operation of an indicia reading apparatus in one embodiment;

FIG. 6 is a block diagram illustrating a laser scanning image data output system;

FIG. 7 is a timing diagram illustrating operation of an indicia reading apparatus having a laser scanning based image data output system.

### DETAILED DESCRIPTION OF THE INVENTION

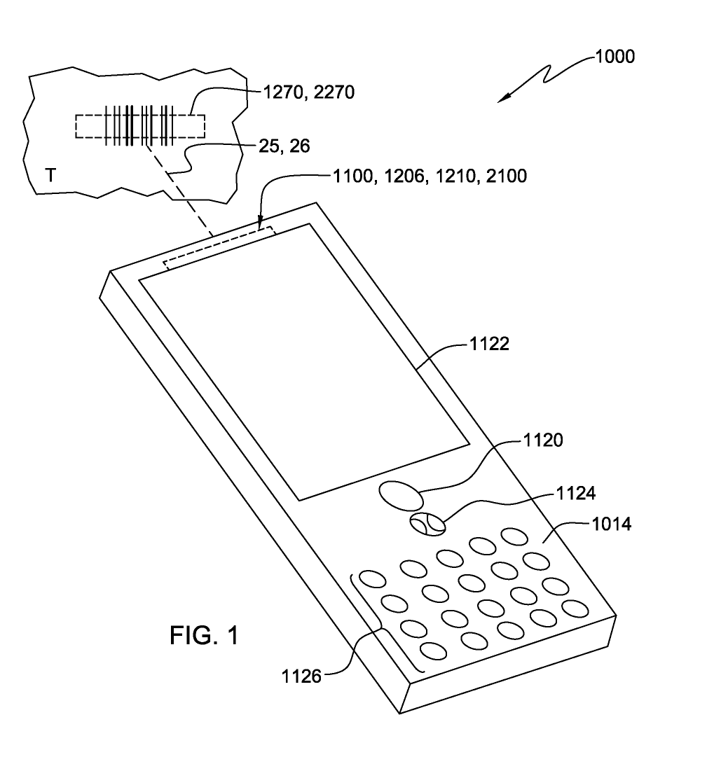

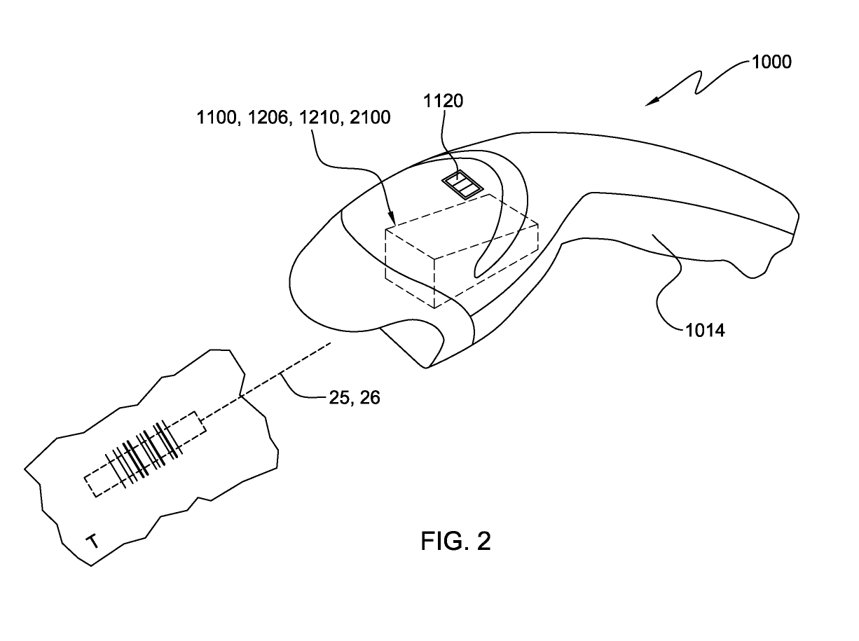

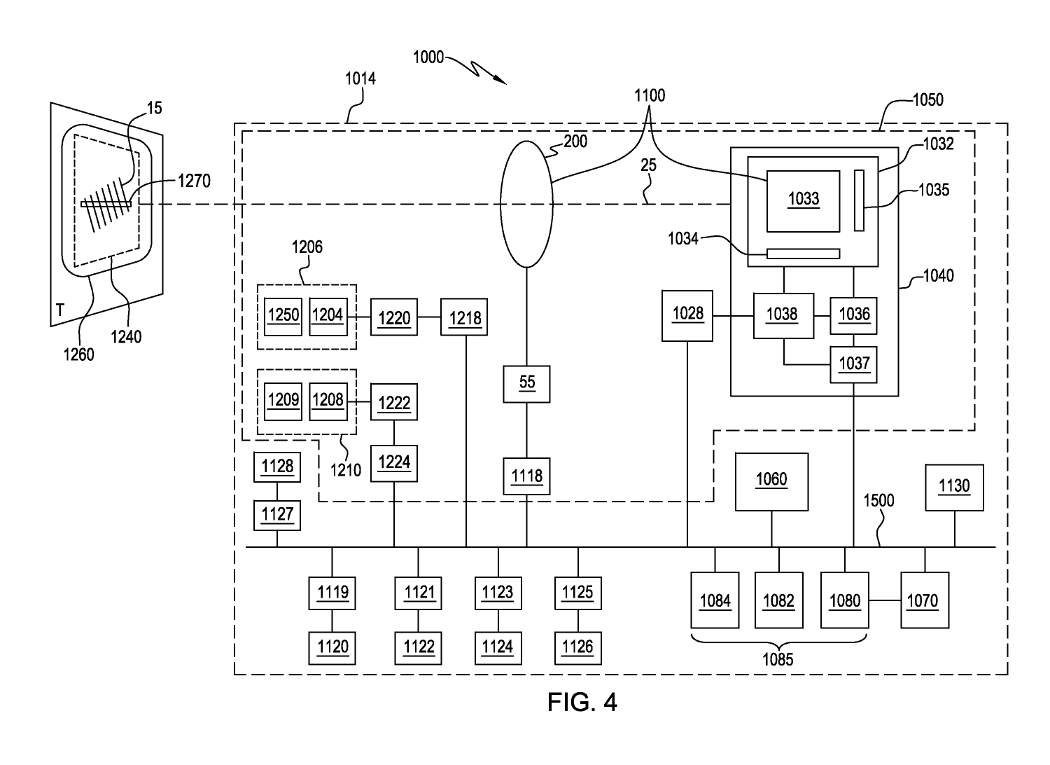

There is set forth herein as shown in FIG. 1 an indicia reading apparatus 1000 having a plurality of configurations that can be activated with use of a manually actuated multiple state trigger 1120. According to a first configuration, the indicia reading apparatus 1000 can project an aiming pattern 1270 while maintaining in an inactive state decoding operations for attempting to decode a decodable indicia by processing of a captured frame of image data. According to a second configuration the indicia reading apparatus 1000 can activate decoding operations. In FIG. 1, indicia reading apparatus 1000 is a type having a manual trigger 1120, a display 1122, and a keyboard 1126. In one embodiment, as shown in FIG. 2, indicia reading apparatus 1000 is a gun style apparatus devoid of a display 1122 and a keyboard 1126 but including a manual trigger 1120. In a further aspect, indicia reading apparatus 1000 can include a hand held housing 1014 in which components of apparatus 1000 as set forth in FIG. 4 can be disposed.

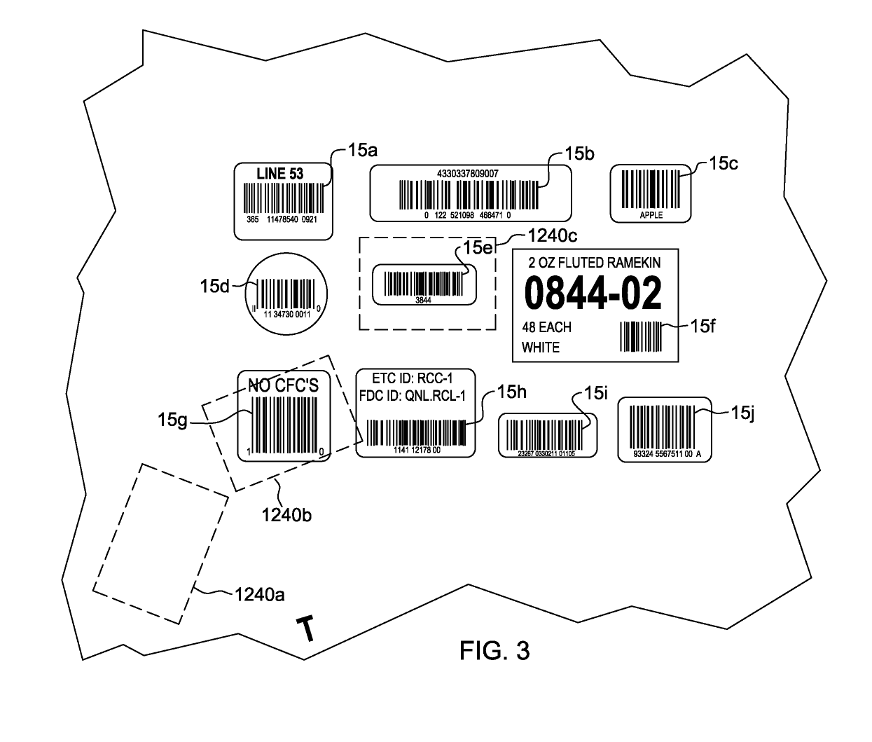

In the development of apparatus 1000 it was noted that a wrong decodable indicia is often decoded with use of prior art indicia reading apparatus. Referring to FIG. 3 there is shown a target substrate T having disposed thereon a plurality of decodable indicia 15a-15j. A user of indicia reading apparatus 1000 may wish to decode one of a center decodable indicia e.g., indicia 15e, but instead may unintentionally decode a decodable indicia at a periphery of the target substrate 15 such as decodable indicia 15g. Fields of view positions 1240a-1240c depict a possible progression of a field of view 1240 (FIG. 4) of an indicia reading apparatus 1000 over time while user attempts to center a field of view on the desired decoded decodable indicia 15e. At time T1, field of view 1240 may be at position 1240a, at time T2 after T1, field of view 1240 may be at position 1240b. At time T3 after time T2, field of view 1240 may be at position 1240c. Only at Time T3 is a field of view 1240 of apparatus 1000 positioned at a position to facilitate reading of the decodable indicia 15e desired to be read. However, in the development of apparatus 1000, it was determined that prior to time T3 a prior art apparatus (not shown) may have previously decoded an unwanted decodable indicia, such as the indicia 15g within field of view position 1240b.

As set forth herein an indicia reading apparatus 1000 can be provided with configurations that can be activated with use of a manually actuated trigger 1120 so that decoding operations can be controlled in a manner that decodable indicia desired to be decoded can be decoded e.g., decodable indicia 15e as shown in FIG. 3 and further that decoding of decodable indicia whose decoding is not desired can be avoided.

An exemplary hardware platform for support of operations described herein with reference to an image sensor based indicia reading terminal is shown and described with reference to FIG. 4.

Indicia reading apparatus 1000 can include an image sensor 1032 comprising a multiple pixel image sensor array 1033 having pixels arranged in rows and columns of pixels, associated column circuitry 1034 and row circuitry 1035. Associated with the image sensor 1032, can be amplifier circuitry 1036 and an analog to digital converter 1037. Analog to digital converter 1037 converts image data in the form of analog signal image data read out of image sensor array 1033 into image data in the form of digital signal image data. Apparatus 1000 can be adapted to output image data using image assembly 1110 (including image sensor array 1033). For example, image sensor array 1033 can output raw analog signal image data, amplifier 1036 can output amplified analog signal image data, and analog to digital converter 1037 can convert analog signal image data into digital form for storage into RAM 1080 for processing by CPU 1060. Referring further to image sensor 1032, image sensor 1032 can also have an associated timing and control circuit 1038 for use in controlling, for e.g., the exposure period of image sensor 1032, gain applied to the amplifier 1036. The noted circuit components 1032, 1036, 1037, and 1038 can be packaged into a common image sensor integrated circuit 1040. In one example, image sensor integrated circuit 1040 can be provided by an MT9V022 image sensor integrated circuit available from Micron Technology, Inc. In another example, image sensor integrated circuit 1040 can incorporate a Bayer pattern filter. In such an embodiment, CPU 1060 prior to subjecting a frame to further processing can interpolate pixel values intermediate of green pixel values for development of a monochrome frame of image data.

In the course of operation of apparatus 1000, image signals can be read out of image sensor 1032, converted and stored into a system memory such as RAM 1080. A memory 1085 of apparatus 1000 can include RAM 1080, a nonvolatile memory such as EPROM 1082 and a storage memory device 1084 such as may be provided by a flash memory or a hard drive memory. In one embodiment, apparatus 1000 can include CPU 1060 which can be adapted to read out image data stored in memory 1080 and subject such image data to various image processing algorithms. Apparatus 1000 can include a direct memory access (DMA) unit 1070 for routing image information read out from image sensor 1032 that has been subject to conversion to RAM 1080. In another embodiment, apparatus 1000 can employ a system bus providing for bus arbitration mechanism (e.g., a PCI bus) thus eliminating the need for a central DMA controller. A skilled artisan would appreciate that other embodiments of the system bus architecture and/or direct memory access components providing for efficient data transfer between the image sensor 1032 and RAM 1080 are within the scope and the spirit of the invention.

Referring to further aspects of apparatus 1000, lens assembly 200 can be adapted for focusing an image of a decodable indicia 15 located within a field of view 1240 on a target substrate T, onto image sensor array 1033. Imaging light rays can be transmitted about imaging axis 25. Lens assembly 200 can be adapted to be capable of multiple focal lengths and multiple best focus distances. A combination of imaging lens assembly 200 and image sensor array 1033 can be regarded as an imaging assembly 1100.

Apparatus 1000 can also include an illumination pattern light source bank 1204 and associated light shaping optics 1205 for generating an illumination pattern 1260 substantially corresponding to a field of view 1240 of apparatus 1000. The combination of bank 1204 and optics 1205 can be regarded as an illumination light pattern assembly 1206. Apparatus 1000 can also include an aiming pattern light source bank 1208 and associated light shaping optics 1209 for generating an aiming pattern 1270 on substrate 1250. The combination of bank 1208 and optics 1209 can be regarded as an aiming light pattern projection assembly 1210. In use, apparatus 1000 can be oriented by an operator with respect to a substrate 1250 bearing decodable indicia 15 in such manner that aiming pattern 1270 is projected on a decodable indicia 15. In the example of FIG. 4, decodable indicia 15 is provided by a 1D bar code symbol. Decodable indicia 15 could also be provided by a 2D bar code symbol or optical character recognition (OCR) characters. Each of illumination pattern light source bank 1204 and aiming pattern light source bank 1208 can include one or more light sources.

Lens assembly 200 can be controlled with use of electrical power input unit 55 which provides energy for changing a plane of optimal focus of lens assembly 200. In one embodiment, an electrical power input unit 55 can operate as a controlled voltage source, and in another embodiment, as a controlled current source. Illumination pattern light source bank 1204 can be controlled with use of illumination pattern light source control circuit 1220. Aiming pattern light source bank 1208 can be controlled with use of aiming pattern light source bank control circuit 1222.

Electrical power input unit 55 can apply signals for changing optical characteristics of lens assembly 200, e.g., for changing a focal length and/or a best focus distance of (a plane of optimum focus of) lens assembly 200. Illumination pattern light source bank control circuit 1220 can send signals to illumination pattern light source bank 1204, e.g., for changing a level of illumination output by illumination pattern light source bank 1204. Aiming pattern light source bank control circuit 1222 can send signals to aiming pattern light source bank 1208, e.g., for changing a level of illumination output by aiming pattern light source bank 1208.

Apparatus 1000 can also include a number of peripheral devices including trigger 1120 which may be used to make active a trigger signal for activating frame readout and/or certain decoding processes. Apparatus 1000 can be adapted so that activation of trigger 1120 activates a trigger signal and initiates a decode attempt. Specifically, apparatus 1000 can be operative so that in response to activation of a certain trigger signal state, a succession of frames can be read out and captured by way of read out of image information from image sensor array 1033 (typically in the form of analog signals) and then storage of the image information after conversion into memory 1080 (which can buffer one or more of the succession of frames at a given time).

CPU 1060 can be operative to subject one or more of the succession of frames to a decode attempt. For attempting to decode a bar code symbol, CPU 1060 can process image data of a frame corresponding to a line of pixel positions (e.g., a row, a column, or a diagonal set of pixel positions) to determine a spatial pattern of dark and light cells and can convert each light and dark cell pattern determined into a character or character string via table lookup. In one embodiment, CPU 1060 can search for decodable indicia starting from a center of a captured frame of image data (i.e., a center pixel position) and proceeding in an outwardly extending search pattern. In one embodiment, the search pattern can be a helical pattern. In one embodiment, the search pattern can include a search of radial search lines extending automatically from a center pixel position. In one embodiment, apparatus 1000 can be adapted so that aiming light pattern projection assembly 1210 projects aiming pattern 1270 at a position proximate a center of a field of view 1240 of apparatus 1000. Accordingly, with aiming pattern 1270 projected on decodable indicia, e.g., as shown in FIG. 4, a representation of decodable indicia 15e can be expected to be represented proximate to a center of captured frame of image data corresponding to field of view 1240, and accordingly easily located with use of a search pattern that commences a search for decodable indicia at a center of a frame of image data.

Apparatus 1000 can include various interface circuits for coupling various of the peripheral devices to system address/data bus (system bus) 1500, for communication with CPU 1060 also coupled to system bus 1500. Apparatus 1000 can include interface circuit 1028 for coupling image sensor timing and control circuit 1038 to system bus 1500, interface circuit 1118 for coupling electrical power input unit 55 to system bus 1500, interface circuit 1218 for coupling illumination light source bank control circuit 1220 to system bus 1500, interface circuit 1224 for coupling aiming light source bank control circuit 1222 to system bus 1500, and interface circuit 1119 for coupling trigger 1120 to system bus 1500. Apparatus 1000 can also include a display 1122 coupled to system bus 1500 and in communication with CPU 1060, via interface 1121, as well as pointer mechanism 1124 in communication with CPU 1060 via interface 1123 connected to system bus 1500. Apparatus 1000 can also include keyboard 1126 in communication with CPU 1060 via interface 1125 connected to system bus 1500. Apparatus 1000 can also include range detector 1128 in communication with CPU 1060 via interface 1127 connected to system bus 1500. Range detector 1128 can be e.g., an ultrasonic range detector. Apparatus 1000 can also include one or more communication interface 1130 e.g., a wireline communication interface (e.g., Ethernet, USB) or a wireless communication interface (e.g., IEEE 802.11, Bluetooth)

A succession of frames of image data that can be captured and subject to the described processing can be full frames (including pixel values corresponding to more than about 80% of pixels of image sensor 1032). A succession of frames of image data that can be captured and subject to the described processing (e.g., frame quality evaluation processing) can also be “windowed frames” comprising pixel values corresponding to less than about 80%, and in some cases less than about 50% and in some cases less than 10% of pixels of image sensor 1032. A succession of frames of image data that can be captured and subject to the described processing can also comprise a combination of full frames and windowed frames. A full frame can be captured by selectively addressing for readout pixels of image sensor 1032 corresponding to the full frame. A windowed frame can be captured by selectively addressing for readout pixels of image sensor 1032 corresponding to the windowed frame.

Apparatus 1000 can capture frames of image data at a rate known as a frame rate. A typical frame rate is 60 frames per second (FPS) which translates to a frame time (frame period) of 16.6 ms. Another typical frame rate is 30 frames per second (FPS) which translates to a frame time (frame period) of 33.3 ms per frame.

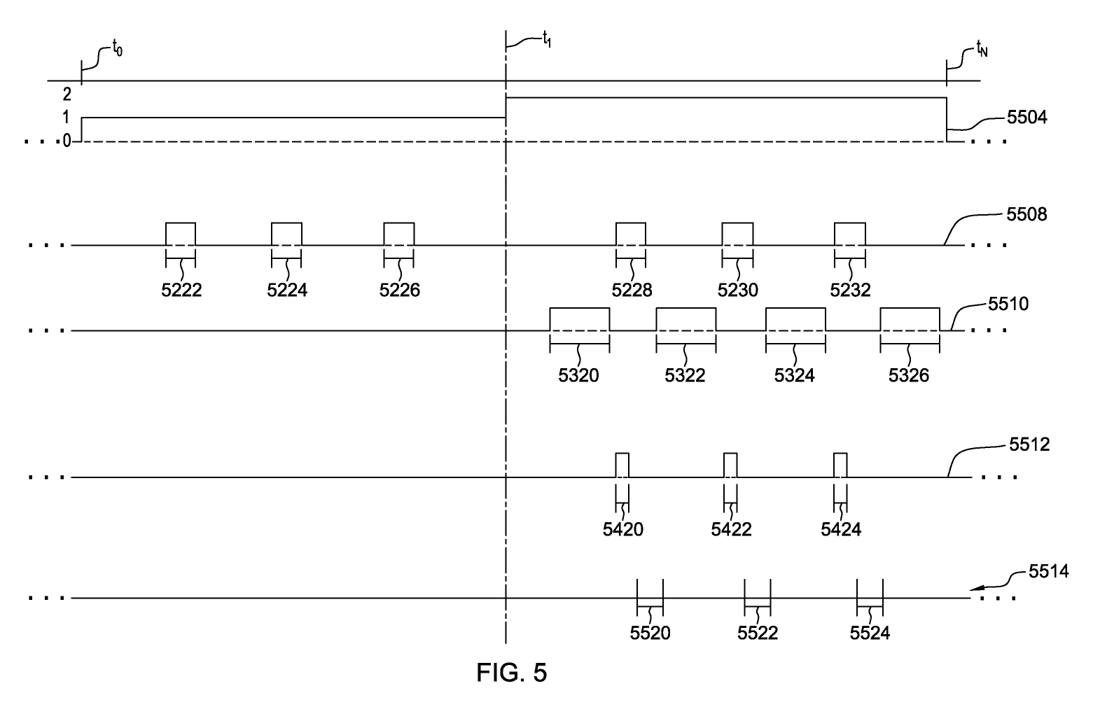

A physical form view of apparatus 1000 in various embodiments is shown in FIGS. 1 and 2. Trigger 1120, display 1122, pointer mechanism 1124, and keyboard 1126 can be disposed on a common side of a hand held housing 1014 as shown in the embodiment of FIG. 1. Display 1122 and trigger 1120 and pointer mechanism 1124 in combination can be regarded as a user interface of apparatus 1000. Display 1122 in one embodiment can incorporate a touch panel for navigation and virtual actuator selection and manual trigger signal activation via a virtual displayed trigger in which case a user interface of apparatus 1000 can be provided by display 1122. A user interface of apparatus 1000 can also be provided by configuring apparatus 1000 to be operative to be reprogrammed by decoding of programming bar code symbols. A hand held housing 1014 for apparatus 1000 can in another embodiment be devoid of a display and can be in a gun style form factor as shown in FIG. 2. Further aspects of apparatus 1000 are set forth in connection with FIG. 5 showing a timing diagram illustrating aspects of apparatus 1000 in one embodiment.

Referring to the timing diagram of FIG. 5, signal 5504 is a trigger signal which as set forth herein can have multiple active states which in one embodiment can be controlled with use of manual trigger 1120. As shown in FIG. 5, trigger signal 5504 can have a first active state represented by logic level “1” a second active state represented by logic level “2” and an inactive state represented by logic level “0”. Apparatus 1000 can be adapted so that the states can be controlled with use of manual trigger 1120. In one embodiment, apparatus 1000 can be adapted so that a first active state represented as logic level “1” in FIG. 5 is established by manually depressing trigger 1120, and can be further adapted so that a second active state represented by logic level “2” is established by subsequently releasing trigger 1120 and can further be adapted so that an inactive state, logic level “0” is established by one of successfully decoding a decodable indicia or by expiration of a timeout after activation of the second active state without a successful decode. Manual trigger 1120 can also be provided according to an alternative embodiment allowing a first depressed position and second further depressed position so that the second active state is established by further depressing in a trigger 1120 to a further extent and further so that an inactive state of trigger signal 5504 represented by logic “0” can be realized by one or more of a successful decode, a timeout or by manually releasing trigger 1120.

Referring to further aspects of an apparatus 1000 operating in accordance with the timing diagram of FIG. 5, signal 5504 is an illumination control signal for controlling a projection of a projected light pattern by apparatus 1000, e.g., aiming pattern 1270. Signal 5510 is an exposure signal. Logic high periods of signal 5510 define exposure periods 5320, 5322, 5324, and 5326. Signal 5512 is a read out signal. Logic high periods of signal 5512 define read out periods 5420, 5422, and 5424. Processing periods 5520, 5522, and 5524 can represent processing periods during which time CPU 1060 of apparatus 1000 processes stored (e.g., buffered) frames representing a target substrate, T, that can bear decodable indicia. Such processing can include processing for attempting to decode a decodable indicia as described herein.

With further reference to the timing diagram of FIG. 5, an operator user at time t=t₀ can establish a first active state of trigger signal 5504 utilizing trigger 1120. With trigger 1120 in a first active state, apparatus 1000 operates in a first configuration. In a first configuration in the specific embodiment described with reference to FIG. 5, aiming light pattern projection assembly 1210 projects aiming pattern 1270. In the specific embodiment depicted with reference to FIG. 5, aiming light pattern projection assembly 1210 projects aiming pattern 1270 during logic high periods of control signal 5508, namely during periods 5222, 5224, 5226, 5228, 5230, 5232. Periods 5222, 5224, 5226 depicted in the timing diagram of FIG. 5 are periods occurring during a time that a first configuration is active. Periods 5228, 5230, 5232 are periods occurring during a time that a second configuration is active. In the embodiment described with reference to the timing diagram at FIG. 5, aiming light pattern projection assembly 1210, as is indicated by periods 5222, 5224, 5226, 5228, 5230, 5232 being discontinuous, projects aiming pattern 1270 on a cycled on and off basis with both the first configuration and second configuration active. In another embodiment light pattern projection assembly 1210 can project aiming pattern 1270 on a continuously on basis when operating in accordance with one or more of the first configuration and second configuration.

With further reference to the timing diagram of FIG. 5, an operator at time, t₁, can establish a second active status of trigger signal 5504 using manual trigger 1120. Apparatus 1000 can be operative so that apparatus 1000 operates in accordance with a second configuration when trigger signal 5504 is in a second active state. In response to trigger signal 5504 being established at a second active state, apparatus 1000 can expose a succession of frames for capture. Further responsively to a trigger signal 5504 being established at a second active state, captured frames during processing periods 5520, 5522, 5524 can be subject to an attempt to decode as has been set forth herein. During each exposure period 5320, 5322, 5324, 5326 a frame of image data can be exposed.

In one embodiment, there are a succession of frames exposed, read out and subject to processing during a time that trigger signal 5504 is established at a second active state. The processing of each frame exposed with the second configuration active can include a decode attempt as described herein. As explained, a trigger signal 5504 can be established at a first active state by depression of trigger 1120 and can be established at a second active state by release of trigger 1120.

Referring to the timing diagram of FIG. 5 apparatus 1000 can be caused to transition between a first configuration and a second configuration by manual control of manual trigger 1120. Apparatus 1000 in the embodiment described with reference to the timing diagram of FIG. 5 is operative to operate in a first configuration with a first active state of a trigger signal 5504 being established and to operate in a second configuration with a second active state of a trigger signal 5504 being activated.

In the embodiment described with reference to the trigger diagram of FIG. 5 exposure of frames captured utilizing image sensor array 1033 is activated responsively to the second configuration being activated. In the embodiment shown in FIG. 5 apparatus 1000 when operating in a first configuration and prior to operating in a second configuration is restricted from exposing and capturing frames of image data utilizing image sensor array 1033. Further in the embodiment described with reference to the timing diagram of FIG. 5, an attempt to decode frames of image data is activated responsively to a second configuration being activated.

In an embodiment that is an alternative to the one described with reference to the timing diagram of FIG. 5, apparatus 1000 can be operative so that in a first configuration active prior to time t=t₁ apparatus 1000 can be exposing and capturing frames of image data when operating in a first configuration but can be restricted from attempting to decode a captured frame until a time that the second configuration activated at time t=t₁.

In either of the set forth embodiments, apparatus 1000 can be used to selectively read a desired decodable indicia within a scene having a plurality of decodable indicia such as the scene corresponding to target T depicted in FIG. 3. For decoding a desired decodable indicia 15e as shown in FIG. 3 apparatus 1000 with trigger signal 5504 in a first active state can be moved relative to a target substrate until a time that an aiming pattern 1270 is centered on a decodable indicia e.g., decodable indicia 15e which a user of apparatus 1000 wishes to decode. With aiming pattern 1270 so centered, a user can control trigger 1120 to activate a second active state of trigger signal 5504 to commence one of more of decoding captured frames of image data and exposure of one or more frame of image data for capture. In such manner decoding of unwanted decodable indicia not desired for decoding can be easily avoided.

In another embodiment, aspects of apparatus 1000 set forth herein can be incorporated into an indicia reading apparatus having a laser scanning based image data output system. Image sensor based image data output system components such as components 1206, 1210, 1220, 1218, 1222, 1224, 200, 1040, 1028, 200, 55, 1118 can be substituted for by laser scanning based image data output system components such as components 2109, 2110, 2114, 2118, 2117, 2122, 2132, 2131, 2128, and 2127 as set forth in

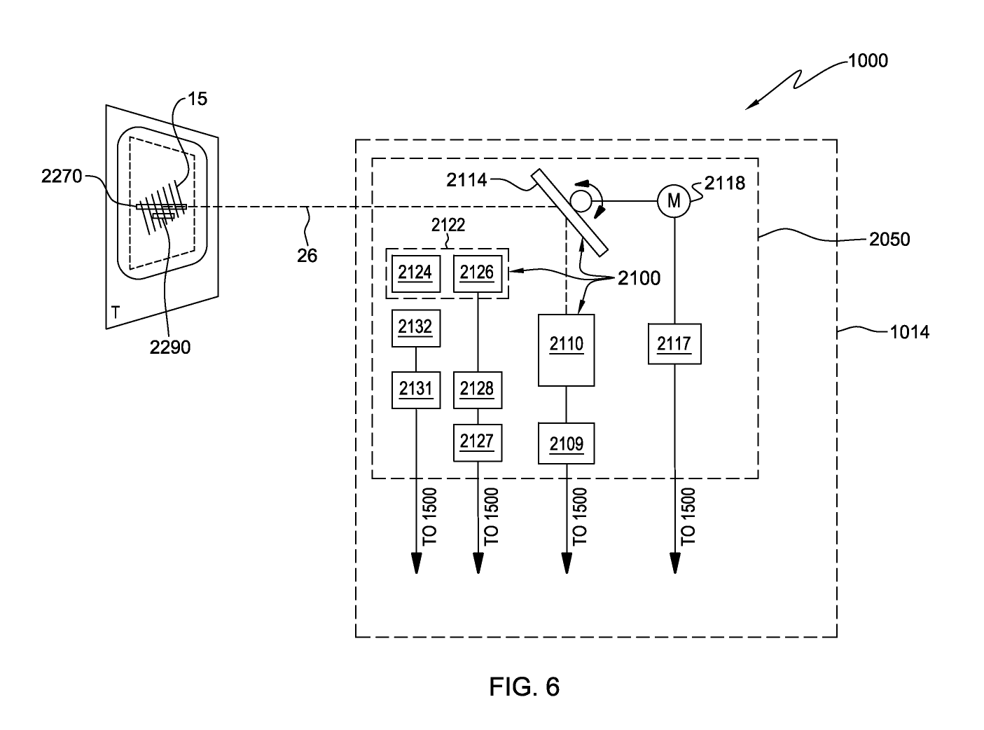

FIG. 6. Laser scanning based image data output system 2050 having laser scanning assembly 2100 and including components 2109, 2110, 2114, 2118, 2117, 2122, 2132, 2131, 2128, and 2127 can be disposed in housing 1014 (FIGS. 1 and 2). In one embodiment, apparatus 1000 can have disposed in housing 1014 both an image sensor based image data output system including imaging assembly 1110 and a laser scanning image data output system including laser scanning assembly 2100. In the embodiment of FIG. 6, a laser scanning based image data output system 2050 can comprise laser diode assembly 2110, a scanning mirror 2114 for projecting scanned laser line 2270 on a target substrate T, a motor 2118 for moving scanning mirror 2114 and a photodiode assembly 2122 for detecting reflected laser light. Laser light can be emitted along axis 26. Photodiode assembly 2122 can include a photodiode 2124 and an integrated amplifier 2126. Apparatus 1000 can output image data using laser scanning assembly 2100. For example, photodiode 2124 can output raw analog image data, amplifier 2126 can output amplified analog signal image data, analog to digital converter 2128 can convert analog signal image data into digital image data and can output digitized image data for storage into RAM 1080. A light pattern projected by laser scanning based image data output system 2050 can include laser line 2270 which can be used by an user of apparatus 1000 for aiming apparatus 1000. A light pattern projected by laser scanning based image data output system 2050 can in one embodiment include aiming pattern light pattern projection assembly 2132 external to assembly 2100 for projection of aiming pattern light pattern 2290 which can be external to scan line 2270. Where apparatus 1000 is adapted to project pattern 2290, pattern 2290 can be used by a user to aim apparatus 1000. Components 2110, 2118, 2128, 2132 can have associated interface circuits 2109, 2117, 2131 for interfacing to system bus 1500 and for providing communication with CPU 1060.

For attempting to decode a bar code symbol, CPU 1060 (FIG. 4) can process digitized image data stored in RAM 1080 corresponding to a scanned, reflected, and detected laser beam to determine a spatial pattern of dark cells and light cells intersected by projected laser beam 2270 and can convert each light and dark cell pattern determined into a character of a character string via table lookup.

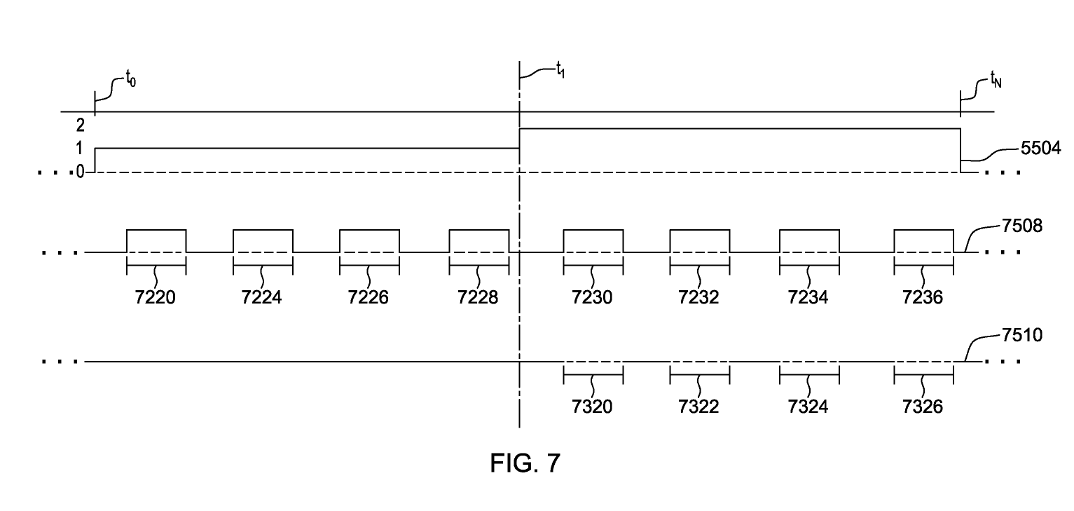

Aspects of operation of an apparatus 100 having a laser scanning system 2050 are set forth with reference to the timing diagram of FIG. 7. Apparatus 1000 can include a first configuration in which the apparatus 1000 projects a light pattern which can be used for aiming the apparatus 1000. Apparatus 1000 can include a second configuration in which the apparatus 1000 is permitted to attempt to decode image data output using laser scanning assembly 2100 (including photodiode 2124) of system 2050. Such image data output using assembly 2100 (including photodiode 2124) can include digital signal image data corresponding to reflected laser light stored in RAM 1080. With a first configuration active, apparatus 1000 can be restricted from attempting to decode image data output using assembly 2100. Apparatus 1000 having system 2050 can also include a second configuration. With a second configuration active, apparatus 1000 can be permitted to attempt to decode decodable indicia represented in output image data. Apparatus 1000 can be operative to control the activation of the first configuration and the second configuration using manual trigger 1120 which can be a multiple state trigger as set forth previously herein. With reference to the timing diagram of FIG. 7 apparatus 1000 prior to time T1 can be controlled with use of trigger 1120 so that the first configuration is active. Apparatus 1000 after time T1 can be controlled with use of trigger 1120 so that the second configuration is active.

Referring to the timing diagram of FIG. 7, signal 5504 is a trigger signal operative as described in connection with FIG. 5 and having multiple active states that can be controlled with use of trigger 1120. Signal 7508 is a signal controlling energization of laser diode assembly 2110 and motor 2118 for projection of scanned laser line 2270, with “on” periods being periods 7222, 7224, 7226, 7228, 7230, 7232, 7234, 7236. In the specific example of FIG. 7, laser line 2270 is controlled to be projected on a “cycled on and off” basis, with “on” periods being periods 7222, 7224, 7226, 7228, 7230, 7232, 7234, 7236. In another embodiment, laser line 2270 can be controlled to be projected on a “continuously on” basis. Referring further to the timing diagram of FIG. 7, periods 7320 are periods in which CPU 1060 processes image data stored in RAM 1080 for attempting to decode decodable indicia. In the specific embodiment described with reference to the timing diagram of FIG. 7, apparatus 1000 can be restricted from storing image data in RAM 1080 with the first configuration active. In an alternative embodiment with the first configuration active, CPU 1060 can process captured image data representing reflected laser light with the first configuration active but its operation can be restricted so that attempting decoding is not permitted with the first configuration active. In the embodiment described with reference to the timing diagram of FIG. 7 with the first configuration active, laser line 2270 can be projected to allow a user to aim apparatus 1000. In an alternative embodiment with the first configuration active light pattern projection assembly 2132 can be energized so that aiming pattern light pattern 2290 can be projected (on a cycled on and off or continuously on basis) in place of or in addition to laser line light pattern 2270 in order to allow a user to aim apparatus 1000.

Referring again to FIG. 2, an apparatus having laser scanning based image data output system 2050 can be operated in the manner of a reading apparatus having an image sensor based image data output system 1050 (FIG. 4). With use of an apparatus 1000 having system 2050 a user can control trigger 1120 to activate a first configuration and can move apparatus 1000 into such position that a light pattern e.g., light pattern 2270 and/or light pattern 2290 is projected proximate (including positions that are “on”) a decodable indicia 15e desired to be read and without risk of undesirably decoding a decodable indicia proximate desired decodable indicia 15e. With apparatus 1000 so positioned, a user can control trigger 1120 so that a second configuration is activated to permit decoding of desired decodable indicia 15e by processing of image data representing decodable indicia 15e.

A small sample of systems, methods and apparatus that are described herein is as follows:
A1. An indicia reading apparatus comprising:

an imaging assembly having an image sensor array and an imaging lens assembly for focusing an image onto the image sensor array;

a light pattern projection assembly for projecting a light pattern;

a manual trigger having multiple states;

a first configuration and a second configuration;

wherein the indicia reading apparatus with the first configuration active is adapted so that the light pattern projection assembly projects the light pattern and is further adapted so that the indicia reading apparatus is restricted from attempting to decode decodable indicia utilizing image data captured with use of the imaging assembly;

wherein the indicia reading apparatus with the second configuration active is adapted so that the indicia reading apparatus is permitted to attempt to decode decodable indicia utilizing image data captured with use of the imaging assembly;

wherein the indicia reading apparatus is adapted so that a user can control a transition of the indicia reading apparatus from the first configuration to the second configuration with use of the manual trigger.
A2. The indicia reading apparatus of claim A1, wherein the indicia reading apparatus is adapted so that the light pattern projection assembly projects the light pattern on a continuously on basis with the first configuration active.
A3. The indicia reading apparatus of A1, wherein the indicia reading apparatus is adapted so that the light pattern projection assembly projects the light pattern on a cycled on and off basis with the first configuration active.
A4. The indicia reading apparatus of A1, wherein with the second configuration active the indicia reading apparatus is further adapted to project the light pattern.
A5. The indicia reading apparatus of A1, wherein with the second configuration active the indicia reading apparatus is further adapted to commence exposure of frames of image data utilizing the imaging assembly.
A6. The indicia reading apparatus of A1, wherein with the first configuration active the indicia reading apparatus is further adapted so that the indicia reading apparatus is restricted from exposing and capturing frames of image data utilizing the imaging assembly.
A7. The indicia reading apparatus of A1, wherein the light pattern projection assembly is an aiming light pattern projection assembly that projects an aiming pattern.
B1. A method for reading a certain decodable indicia comprising:

providing an hand held indicia reading apparatus having an imaging assembly including an image sensor array and an imaging lens assembly for focusing an image onto the image sensor array, a light pattern projection assembly for projecting a light pattern, a manual trigger having multiple states, a first configuration and a second configuration each of which can be made active by control of the manual trigger, wherein the providing includes providing the indicia reading apparatus so that with the first configuration active the light pattern projection assembly projects the light pattern and the indicia reading apparatus is restricted from attempting to decode decodable indicia utilizing image data captured with use of the imaging assembly, wherein the providing further including providing the indicia reading apparatus so that with the second configuration active the indicia reading apparatus is permitted to attempt to decode decodable indicia utilizing image data captured with use of the imaging assembly;

controlling the manual trigger to activate the first configuration;

manually moving the indicia reading terminal with the first configuration active until the light pattern is projected onto the certain decodable indicia; and

controlling the manual trigger to activate the first configuration to permit decoding of the decodable indicia.
B2. The method of B1, wherein the providing includes providing the indicia reading apparatus so that the light pattern projection assembly projects the light pattern on a continuously on basis with the first configuration active.
B3. The method of B1, wherein the providing includes providing the indicia reading apparatus so that the light pattern projection assembly projects the light pattern on a cycled on and off basis with the first configuration active.
B4. The method of B1, wherein the providing includes providing the indicia reading apparatus so that with the second configuration active the indicia reading apparatus is further adapted to project the light pattern.
B5. The method of B1, wherein the providing includes providing the indicia reading apparatus so that with the second configuration active the indicia reading apparatus is further adapted to commence exposure of frames of image data utilizing the imaging assembly.
B6. The method of B1, wherein the providing includes providing the indicia reading apparatus so that with the first configuration active the indicia reading apparatus is further adapted so that the indicia reading apparatus is restricted from exposing and capturing frames of image data utilizing the imaging assembly.
B7. The method of B1, wherein the providing includes providing the indicia reading apparatus so that the light pattern projection assembly is an aiming light pattern projection assembly that projects an aiming pattern.
C1. An indicia reading apparatus comprising:

an image data output system for outputting image data;

a light pattern projection assembly for projecting a light pattern;

a manual trigger having multiple states;

a first configuration and a second configuration;

wherein the indicia reading apparatus with the first configuration active is adapted to that the light pattern is projected and further so that the indicia reading apparatus is restricted from attempting to decode decodable indicia utilizing image data output by the image data output system;

wherein the indicia reading apparatus with the second configuration active is adapted so that the indicia reading apparatus is permitted to attempt to decode decodable indicia utilizing image data output by the image data output system;

wherein the indicia reading apparatus is adapted so that a user can control a transition of the indicia reading apparatus from the first configuration to the second configuration with use of the manual trigger.
C2. The indicia reading apparatus of claim C1, wherein the indicia reading apparatus is adapted so that the light pattern projection assembly projects the light pattern on a continuously on basis with the first configuration active.
C3. The indicia reading apparatus of claim C1, wherein the indicia reading apparatus is adapted so that the light pattern projection assembly projects the light pattern on a cycled on and off basis with the first configuration active.
C4. The indicia reading apparatus of claim C1, wherein with the second configuration active the indicia reading apparatus is further adapted to project the light pattern.
C5. The indicia reading apparatus of claim C1, wherein the image data output system includes a laser scanning assembly.
C6. The indicia reading apparatus of claim C1, wherein the image data output system includes an image sensor array.
C7. The indicia reading apparatus of claim C1, wherein the image data output system includes a laser scanning assembly, and wherein the light pattern is a scanned laser line projected by the laser scanning assembly.
C8. The indicia reading apparatus of claim C1, wherein the image data output system includes a laser scanning assembly, and wherein the light pattern is a light pattern projected by a light pattern projection assembly external to the laser scanning assembly.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than or greater than the mentioned certain number of elements. Also, while a number of particular embodiments have been described, it will be understood that features and aspects that have been described with reference to each particular embodiment can be used with each remaining particularly described embodiment.

We claim:

1. An indicia reading apparatus comprising:
an imaging assembly having an image sensor array and an imaging lens assembly for focusing an image onto the image sensor array;
a light pattern projection assembly for projecting a light pattern;
a manual trigger having multiple states;
a first configuration and a second configuration;
wherein the indicia reading apparatus with the first configuration active is adapted so that the light pattern projection assembly projects the light pattern and is further adapted so that the indicia reading apparatus is restricted from attempting to decode decodable indicia utilizing image data captured with use of the imaging assembly;
wherein the indicia reading apparatus with the second configuration active is adapted so that the indicia reading apparatus is permitted to attempt to decode decodable indicia utilizing image data captured with use of the imaging assembly;
wherein the indicia reading apparatus is adapted so that a user can control a transition of the indicia reading apparatus from the first configuration to the second configuration with use of the manual trigger.

2. The indicia reading apparatus of claim 1, wherein the indicia reading apparatus is adapted so that the light pattern projection assembly projects the light pattern on a continuously on basis with the first configuration active.

3. The indicia reading apparatus of claim 1, wherein the indicia reading apparatus is adapted so that the light pattern projection assembly projects the light pattern on a cycled on and off basis with the first configuration active.

4. The indicia reading apparatus of claim 1, wherein with the second configuration active the indicia reading apparatus is further adapted to project the light pattern.

5. The indicia reading apparatus of claim 1, wherein with the second configuration active the indicia reading apparatus is further adapted to commence exposure of frames of image data utilizing the imaging assembly.

6. The indicia reading apparatus of claim 1, wherein with the first configuration active the indicia reading apparatus is further adapted so that the indicia reading apparatus is restricted from exposing and capturing frames of image data utilizing the imaging assembly.

7. The indicia reading apparatus of claim 1, wherein the light pattern projection assembly is an aiming light pattern projection assembly that projects an aiming pattern.

8. A method for reading a certain decodable indicia comprising:
providing an hand held indicia reading apparatus having an imaging assembly including an image sensor array and an imaging lens assembly for focusing an image onto the image sensor array, a light pattern projection assembly for projecting a light pattern, a manual trigger having multiple states, a first configuration and a second configuration each of which can be made active by control of the manual trigger, wherein the providing includes providing the indicia reading apparatus so that with the first configuration active the light pattern projection assembly projects the light pattern and the indicia reading apparatus is restricted from attempting to decode decodable indicia utilizing image data captured with use of the imaging assembly, wherein the providing further including providing the indicia reading apparatus so that with the second configuration active the indicia reading apparatus is permitted to attempt to decode decodable indicia utilizing image data captured with use of the imaging assembly;
controlling the manual trigger to activate the first configuration;
manually moving the indicia reading terminal with the first configuration active until the light pattern is projected onto the certain decodable indicia; and
controlling the manual trigger to activate the firs configuration to permit decoding of the decodable indicia.

9. The method of claim 8, wherein the providing includes providing the indicia reading apparatus so that the light pattern projection assembly projects the light pattern on a continuously on basis with the first configuration active.

10. The method of claim 8, wherein the providing includes providing the indicia reading apparatus so that the light pattern projection assembly projects the light pattern on a cycled on and off basis with the first configuration active.

11. The method of claim 8, wherein the providing includes providing the indicia reading apparatus so that with the second configuration active the indicia reading apparatus is further adapted to project the light pattern.

12. The method of claim 8, wherein the providing includes providing the indicia reading apparatus so that with the second configuration active the indicia reading apparatus is further adapted to commence exposure of frames of image data utilizing the imaging assembly.

13. The method of claim 8, wherein the providing includes providing the indicia reading apparatus so that with the first configuration active the indicia reading apparatus is further adapted so that the indicia reading apparatus is restricted from exposing and capturing frames of image data utilizing the imaging assembly.

14. The method of claim 8, wherein the providing includes providing the indicia reading apparatus so that the light pattern projection assembly is an aiming light pattern projection assembly that projects an aiming pattern.

15. An indicia reading apparatus comprising:
an image data output system for outputting image data;
a light pattern projection assembly for projecting a light pattern;
a manual trigger having multiple states;
a first configuration and a second configuration;
wherein the indicia reading apparatus with the first configuration active is adapted to that the light pattern is projected and further so that the indicia reading apparatus is restricted from attempting to decode decodable indicia utilizing image data output by the image data output system;
wherein the indicia reading apparatus with the second configuration active is adapted so that the indicia reading apparatus is permitted to attempt to decode decodable indicia utilizing image data output by the image data output system;
wherein the indicia reading apparatus is adapted so that a user can control a transition of the indicia reading apparatus from the first configuration to the second configuration with use of the manual trigger.

16. The indicia reading apparatus of claim 15, wherein the indicia reading apparatus is adapted so that the light pattern projection assembly projects the light pattern on a continuously on basis with the first configuration active.

17. The indicia reading apparatus of claim 15, wherein the indicia reading apparatus is adapted so that the light pattern projection assembly projects the light pattern on a cycled on and off basis with the first configuration active.

18. The indicia reading apparatus of claim 15, wherein with the second configuration active the indicia reading apparatus is further adapted to project the light pattern.

19. The indicia reading apparatus of claim 15, wherein the image data output system includes a laser scanning assembly.

20. The indicia reading apparatus of claim 15, wherein the image data output system includes an image sensor array.

21. The indicia reading apparatus of claim 15, wherein the image data output system includes a laser scanning assembly, and wherein the light pattern is a scanned laser line projected by the laser scanning assembly.

22. The indicia reading apparatus of claim 15, wherein the image data output system includes a laser scanning assembly, and wherein the light pattern is a light pattern projected by a light pattern projection assembly external to the laser scanning assembly.
